(19) United States
(12) Patent Application Publication
(10) Pub. No.: US 2016/0239499 A1
(43) Pub. Date: Aug. 18, 2016

(54) Object Creation Based on Copying Objects Corresponding to Similar Entities

(71) Applicant: Red Hat, Inc., Raleigh, NC (US)

(72) Inventors: Filip Nguyen, Brno (CZ); Filip Elias, Vysni Lhoty (CZ)

(21) Appl. No.: 14/620,704

(22) Filed: Feb. 12, 2015

(51) Int. Cl. G06F 17/30; G06F 17/27

(52) U.S. Cl. CPC G06F 17/3071; G06F 17/2705

(57) ABSTRACT

An example method of providing a list of entities includes obtaining a list of entities responsive to a request from a client. Each entity in the list includes a set of attribute name-value pairs. The method also includes recursively dividing the list of entities into subgroups and for each division resulting in a plurality of subgroups including one or more entities, and assigning a subgroup number to each of the corresponding entity's attribute names by which the division is based. The method also includes generating a logical message tree of entities. The method further includes sorting the list of entities based on the order of the entities in the logical message tree and serializing the sorted list of entities into a data stream. The method also includes transmitting a list of subgroup numbers and the entities in the sorted order over a network to the client.

### BACKGROUND

The Web has become a main source of information and is part of society's everyday tool set. Representational State Transfer (REST) is a communications style that allows a client machine, for example a computer running a Web browser, to communicate to a server, for example a computer running a service. REST Web services are resources accessed by users through, for example, a Web browser. RESTful Web services allow simpler application development and are ideal for interaction with Web browsers via JavaScript or Asynchronous JavaScript and XML (AJAX). REST has become the predominant Web service design, favored by mainstream Web service providers.

Client-server communication is “stateless” between requests, meaning each REST interaction typically contains the information for a component to understand the message. REST is considered a “lightweight” protocol suitable for distributed hypermedia systems. REST is a set of constraints based on the architectural style of the World Wide Web. The REST architecture includes one or more clients and one or more servers. Clients make state transitions through actions (requests to servers to obtain or change the state of resources), and servers process the requests and return appropriate resources. A resource may be any logical concept that is understood by both the client and server, and it is transmitted in an agreed-upon representation. In an example, a resource on the Web may be identified by a uniform resource identifier (URI), which is a unique identifier for a resource. A representation is any useful information about the state of a resource.

REST does not depend on or specify the resource type or representation. Resources may be any type of data imaginable. For example, their representations may be plain text, Hypertext Markup Language (HTML), Extensible Markup Language (XML), Yet Another Multicolumn Layout (YAML), JavaScript Object Notation (JSON), binary data, or any other format understood by both the client and server. REST systems may operate using URIs that indicate the resource type, verbs that indicate the action to be performed on the resource, and/or media types (e.g., MIME types) that indicate the representation of the resource in the request and in the response.

In the REST style, a data object is uniquely named using a Uniform Resource Identifier (URI). The REST style uses operations such as GET, PUT, POST, HEAD, and DELETE. The REST style is loosely coupled, human readable, and stateless between requests. Other characteristics of REST are described in Roy Fielding's doctoral dissertation, “Architectural Styles and the Design of Network-based Software Architectures,” University of California, Irvine. REST was initially described for use with Hypertext Transfer Protocol (HTTP) but is not limited to that protocol. Because REST works well for distributed, collaborative, hypermedia information systems, it has become a popular approach for supporting the World Wide Web (WWW).

### BRIEF SUMMARY

According to an embodiment, a method of providing a list of entities includes obtaining, at a server, a list of entities responsive to a request from a client. Each entity in the list includes a set of attribute name-value pairs. The method also includes recursively dividing the list of entities into subgroups based on an attribute name in the set until each entity in the corresponding subgroup has the same attribute name-value pairs. The method further includes for each division resulting in a plurality of subgroups including one or more entities, assigning a subgroup number to each of the corresponding entity's attribute names by which the division is based. Each entity in a common subgroup of the plurality of subgroups has the same subgroup number. The method also includes generating, at a parser, a logical message tree of entities, an order of the entities in the logical message tree being based on the assigned subgroup numbers. The method further includes sorting the list of entities based on the order of the entities in the logical message tree. The method also includes serializing the sorted list of entities into a data stream. The method further includes transmitting the entities in the sorted order over a network to the client. The method also includes transmitting a list of subgroup numbers to the client, the list of subgroup numbers being based on the assigning.

According to another embodiment, a system for providing a list of entities includes a server that obtains a list of entities responsive to a request from a client. Each entity in the list includes a set of attribute name-value pairs. The system also includes a sort module that recursively divides the list of entities into subgroups based on an attribute name in the set until each entity in the corresponding subgroup has the same attribute name-value pairs. For each division resulting in a plurality of subgroups including one or more entities, the sort module assigns a subgroup number to each of the corresponding entity's attribute names by which the division is based. Each entity in a common subgroup of the plurality of subgroups has the same subgroup number. The system further includes a parser that generates a logical message tree of entities. An order of the entities in the logical message tree is based on the assigned subgroup numbers. The parser sorts the list of entities based on the order of the entities in the logical message tree. The system also includes a serializer that serializes the sorted list of entities into a data stream, and transmits a list of subgroup numbers and the entities in the sorted order over a network to the client. The list of subgroup numbers is based on the subgroup number assignments.

According to another embodiment, a non-transitory machine-readable medium includes a plurality of machine-readable instructions that when executed by one or more processors are adapted to cause the one or more processors to perform a method including: obtaining, at a server, a list of entities responsive to a request from a client, each entity in the list including a set of attribute name-value pairs; recursively dividing the list of entities into subgroups based on an attribute name in the set until each entity in the corresponding subgroup has the same attribute name-value pairs; for each division resulting in a plurality of subgroups including one or more entities, assigning a subgroup number to each of the corresponding entity's attribute names by which the division is based, each entity in a common subgroup of the plurality of subgroups having the same subgroup number; generating, at a parser, a logical message tree of entities, an order of the entities in the logical message tree being based on the assigned subgroup numbers; sorting the list of entities based on the order of the entities in the logical message tree; serializing the sorted list of entities into a data stream; transmitting the entities in the sorted order over a network to the client; and transmitting a list of subgroup numbers to the client, the list of subgroup numbers being based on the assigning.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for ordering a list of entities, according to some embodiments.

FIG. 2 is an example of an unsorted list of entities, according to some embodiments.

FIG. 3A illustrates a first level division of the unsorted list of entities into a plurality of subgroups based on the attribute name “state,” according to some embodiments. FIG. 3B illustrates a second level division of the unsorted list of entities into subgroups based on the attribute name “age” for a subgroup and the attribute name “name” for another subgroup, according to some embodiments. FIG. 3C illustrates a third level of division of the unsorted list of entities into a plurality of subgroups based on the attribute name “name,” according to some embodiments. FIG. 3D illustrates a logical message tree of entities created based on the divisions illustrated in FIGS. 3A-3C, according to some embodiments.

FIG. 4 is a flowchart illustrating a method of providing a list of entities, according to some embodiments.

FIG. 5 is a flowchart illustrating a method of converting entities into objects, according to some embodiments.

FIG. 6 is a block diagram of an electronic system suitable for implementing one or more embodiments of the present disclosure.

### DETAILED DESCRIPTION

### I. Overview

### II. Example System Architecture

### III. Server Sorts the List of Entities Based on Similarity and Generates a Logical Message Tree

A. First Level of Division Based on “State” Attribute Name

B. Recursively Divide the Subgroups Based on an Attribute Name
1. Second Level of Division
   a. Division Based on State Subgroup “0” and Attribute Name “Age”
   b. Division Based on State Subgroup “1” and Attribute Name “Name”
2. Third Level of Division Based on State Subgroup “0,” Age Subgroup “1,” and Attribute Name “Name”

C. List of Subgroup Numbers

### IV. Client-Side Instantiation and Copying of Object Instances

### V. Example Methods

### VI. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

A client may send a request to a server. To service the request, the server may retrieve a list of entities and transmit it to the client. The client may instantiate the entities into objects so that they are easier to work with. The client may include a client application written in a high-level programming language. In an example, the high-level programming language is an object-oriented programming language that defines classes. An object may have state and behavior and represent an instance of a class. The object's state may be described as its fields and properties, and the object's behavior may be described by its methods and events.

The client may instantiate each entity in the list of entities into objects. An instance of a class may expose methods and fields defined by that class. An instruction in a program may include an operator that creates a new instance of a class. For example, the instruction may include the “new” keyword, which is a JAVA® operator that creates an object. In an example, the list of entities may be in a JavaScript Object Notation (JSON) data format, and the client may desire to convert the JSON data into JAVA® objects because they are easier to work with. Trademarks are the property of their respective owners. Although the present disclosure may describe the client application as being a JAVA application, it should be understood that the techniques in the disclosure apply to any object-oriented programming language.

To instantiate a new instance of a class in the object-oriented programming language, the client may read the metadata associated with the class, allocate memory for the newly instantiated instance, and then create the object. The client maps an entity in the list of entities to the object, and sets each of the object's fields based on the corresponding entity's attributes. In an example, the client may read each of the values corresponding to the attributes in the JSON data and set the values in the object's fields. This may be time consuming and use a great deal of resources, especially if the list of entities includes a high number of entities and/or the entities have a high number of tuples.

It may be advantageous to reduce the number of objects that are created. For example, it may be desirable for the client to create only a few new objects and copy the others based on entity similarity. For example, the client may create a new object for a first entity and determine that the first entity is similar to a second entity in the list. The client may copy the new object, which stores fields and their values corresponding to the first entity, and store the copy into memory. Copying an object may include copying the content of the object bit-by-bit, and the copy has the same contents as the original object. The client may modify the field values in the copy to reflect the second entity's attributes such that the copy represents the second entity. Accordingly, it may be unnecessary for the client to create a new object for the second entity. Rather, the client may leverage the already created object representative of the first entity, copy this object, and modify some fields (if any) in the copy such that the copy is representative of the second entity.

The present disclosure provides techniques to re-order the entities the server transmits to the client so that the client can reduce the number of objects that are created. The order in which the entities are sent to the client is conducive to the client copying the contents of a newly created object to represent another entity rather than creating a new object for the other entity and setting the object's fields from scratch.

### II. Example System Architecture

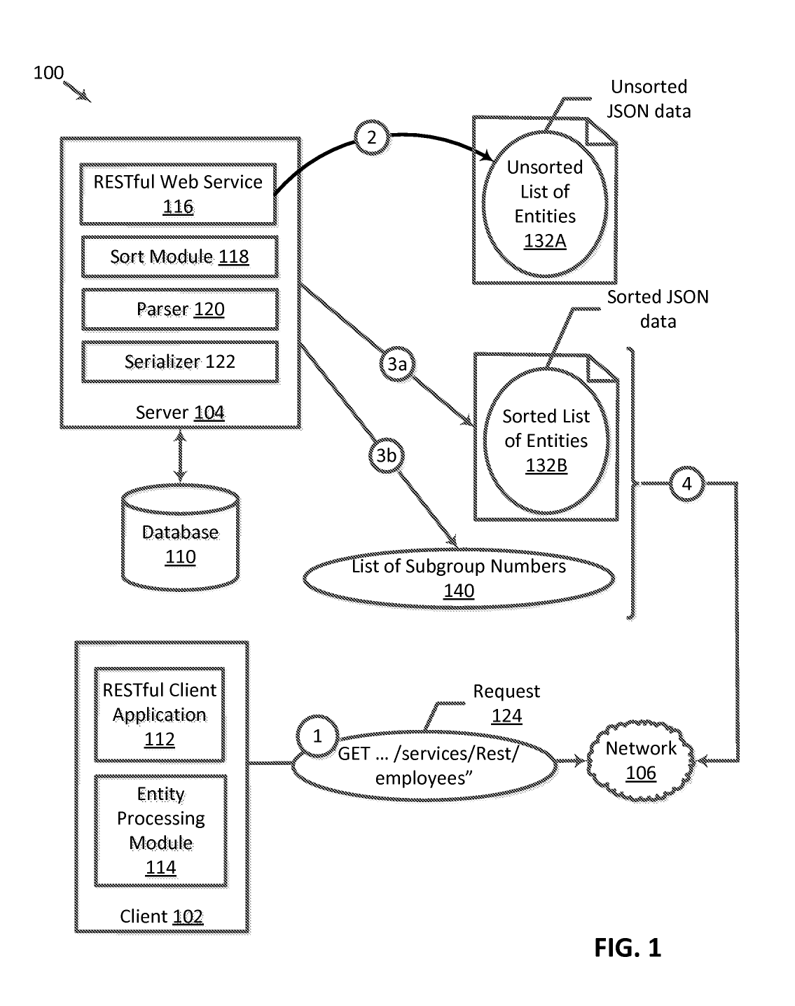

FIG. 1 is a block diagram illustrating a system 100 for ordering a list of entities, according to some embodiments. FIG. 1 includes a client 102 and server 104 coupled over a network 106. Although one client and one server are illustrated, other embodiments including more than one client and/or more than one server are within the scope of the present disclosure. Network 106 may include various configurations and use various protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, WiFi and HTTP, and various combinations of the foregoing.

Server 104 provides a software system, and client 102 desires to access that system. Client 102 includes a RESTful client application 112 and an entity processing module 114, and server 104 includes a RESTful web service 116, sort module 118, parser 120, and serializer 122. Each of RESTful web service 116, sort module 118, parser 120, serializer 122, RESTful client application 112, and entity processing module 114 may be implemented on a computing device that includes a memory and a processor.

Client 102 and server 104 may use a stateless protocol to communicate. In an example, the stateless protocol is HTTP, which is based on requests and responses exchanged between a client and server. In this example, no data is stored between requests from one component to another. RESTful client application 112 may be tied to HTTP and may be a client application built on top of a REST protocol. Similarly, RESTful web service 116 may be tied to HTTP and may be a web service built on top of a REST protocol. RESTful web service 116 is independent of data format and may be a way to share data among several applications (e.g., RESTful client application 112).

Client 102 and server 104 exchange representations of resources using a defined interface and protocol. In FIG. 1, RESTful client application 112 sends a request 124 for one or more resources to server 104. Request 124 may be an HTTP GET request that requests the representation of the resources. In an example, request 124 includes a URI such as “/services/Rest/employees” and indicates that RESTful client application 112 wants to obtain a list of all employees or a filtered list of employees. RESTful client application 112 interacts with a resource through its representation. The resources that RESTful client application 112 desires to access remains on server 104, and request 124 does not change the state of the resources. Rather, request 124 is idempotent, which means that the request leaves the resource in the same state when called.

Server 104 receives request 124 and processes it. Server 104 may obtain data responsive to the request from, for example, database 110. Database 110 may be a relational database that stores data about the employees. Server 104 receives a result set including the employee data from database 110, and converts the result set into a list of entities 132. List of entities 132 may include a plurality of entities of the same type. For example, each entity in list of entities 132 may be of the type “employee.” Each entity has a set of tuples, and each tuple includes an attribute name-value pair. List of entities 132 may be in a data-interchange format such as JSON, XML, or some other data-interchange format.

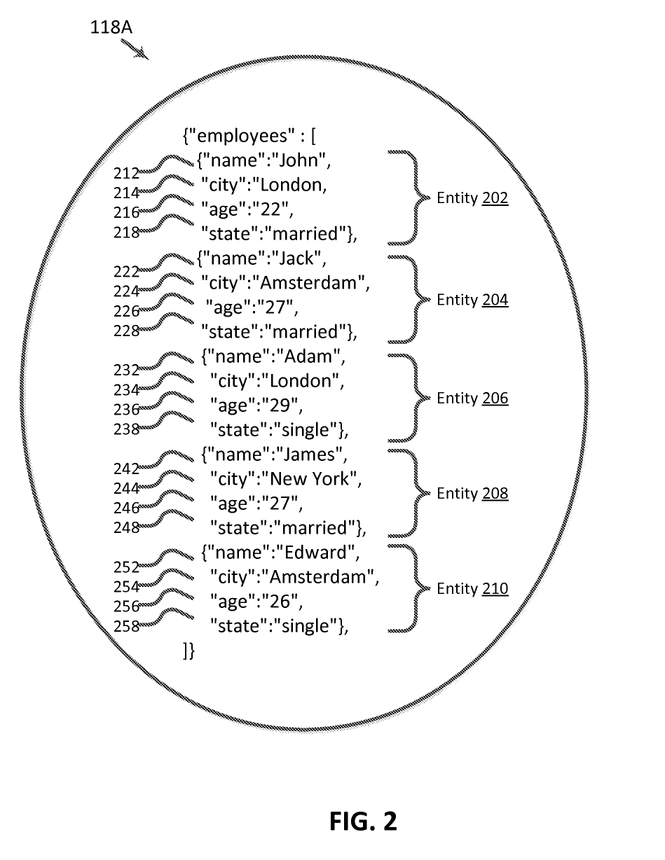

FIG. 2 is an example of an unsorted list of entities 132A, according to some embodiments. In FIG. 2, the order of entities in unsorted list of entities 132A starts with entity 202, to entities 204, 206, 208, and lastly entity 210. Unsorted list of entities 132A is in an unsorted JSON data format because the entities are not ordered based on their similarities. JSON is a lightweight data-interchange format that may be less verbose and more readable than XML. An advantage of using JSON may be that it is directly consumable by JavaScript code in web pages. Although unsorted list of entities 132A is described as being in the JSON data-interchange format, it should be understood that the list of entities may be in another data-interchange format (e.g., XML).

In the example illustrated in FIG. 2, unsorted list of entities 132A includes five entities of an “employee” type. Each “employee” entity includes a set of M tuples, where M is a positive integer. Unsorted list of entities 132A includes an entity 202, entity 204, entity 206, entity 208, and entity 210. Each of the entities in unsorted list of entities 132A has four tuples and a common set of attribute names “name,” “city,” “age,” and “state.” Entity 202 includes a tuple <“name”: “John”> 212, tuple <“city”: “London”> 214, tuple <“age”: “22”> 216, and tuple <“state”: “married”> 218. Entity 204 includes a tuple <“name”: “Jack”> 222, tuple <“city”: “Amsterdam”> 224, tuple <“age”: “27”> 226, and tuple <“state”: “married”> 228. Entity 206 includes a tuple <“name”: “Adam”> 232, tuple <“city”: “London”> 234, tuple <“age”: “29”> 236, and tuple <“state”: “single”> 238. Entity 208 includes a tuple <“name”: “James”> 242, tuple <“city”: “New York”> 244, tuple <“age”: “27”> 246, and tuple <“state”: “married”> 248. Entity 210 includes a tuple <“name”: “Edward”> 252, tuple <“city”: “Amsterdam”> 254, tuple <“age”: “26”> 256, and tuple <“state”: “single”> 258.

The order of entities in unsorted list of entities 132A is not based on entity similarities. Client 102 creates a new object for each of the entities and individually sets each of the object's fields. Rather than pass unsorted list of entities 132A to client 102, it may be desirable for server 104 to reorder the entities based on a similarity among the entities in the list and send the sorted list of entities to client 102.

### III. Server Sorts the List of Entities Based on Similarity and Generates a Logical Message Tree

Sort module 118 groups the more similar entities together and orders them based on their similarities. Sort module 118 may find matching attribute name-value pairs among the entities and sort the entities in an order based on those having the most matches. Two entities have matching attribute name-value pairs if their attribute names and values are the same (have the same tuple). The more matching attribute name-value pairs entities have, the more similar they are to each other.

In some embodiments, sort module 118 recursively divides the list of entities into subgroups based on a number of matching attribute name-value pairs. Sort module 118 may recursively divide the list of entities into subgroups based on an attribute name in the set until each entity in a subgroup has the same tuples. Each level of division is based on an attribute name, where each entity in a common subgroup has a matching value for that attribute name.

For each division resulting in a plurality of subgroups including one or more entities, sort module 118 assigns a subgroup number to each of the subgroups. The subgroup number may represent the subgroup to which an entity is assigned based on the division. At each level of division, each entity in a common subgroup of the plurality of subgroups has the same subgroup number. Sort module 118 remembers the attribute name by which each division is made, and assigns the subgroup number to which the entity belongs to the entity's attribute name.

Parser 120 generates a logical message tree of entities, where an order of the entities in the logical message tree is based on the assigned subgroup numbers. Serializer 122 serializes the logical message tree into a data stream, and transmits the entities in the tree order over a network to the client. Server 104 also transmits the list of subgroup numbers to client 102, where the list of subgroup numbers includes attribute names by which divisions were based along with their subgroup number assignments.

### A. First Level of Division Based on “State” Attribute Name

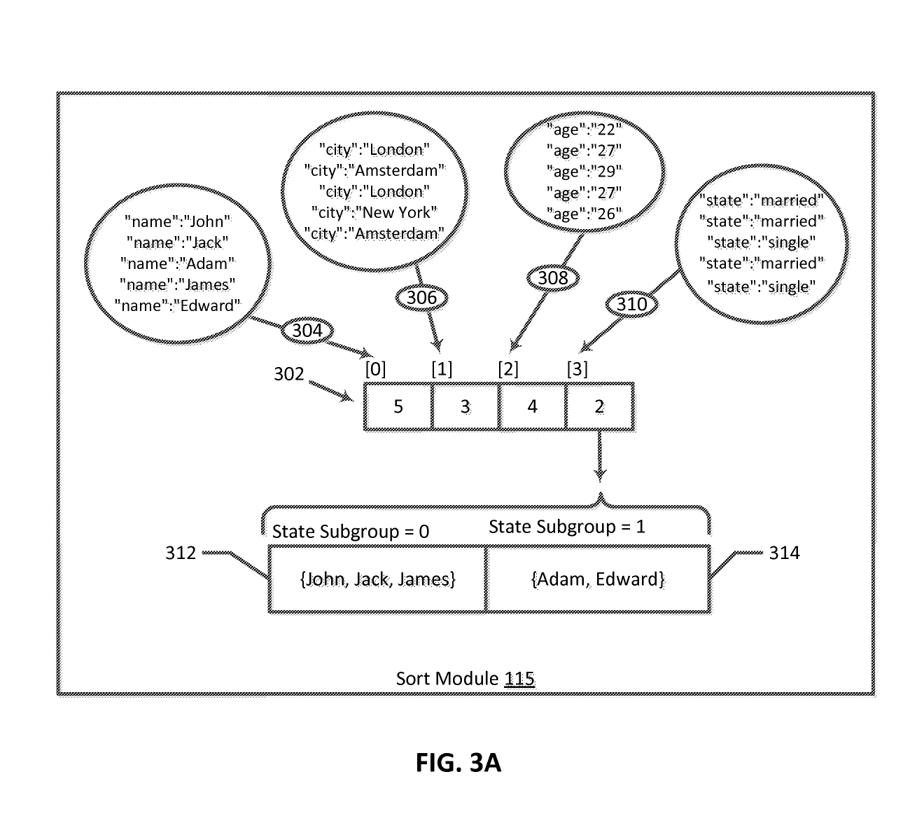

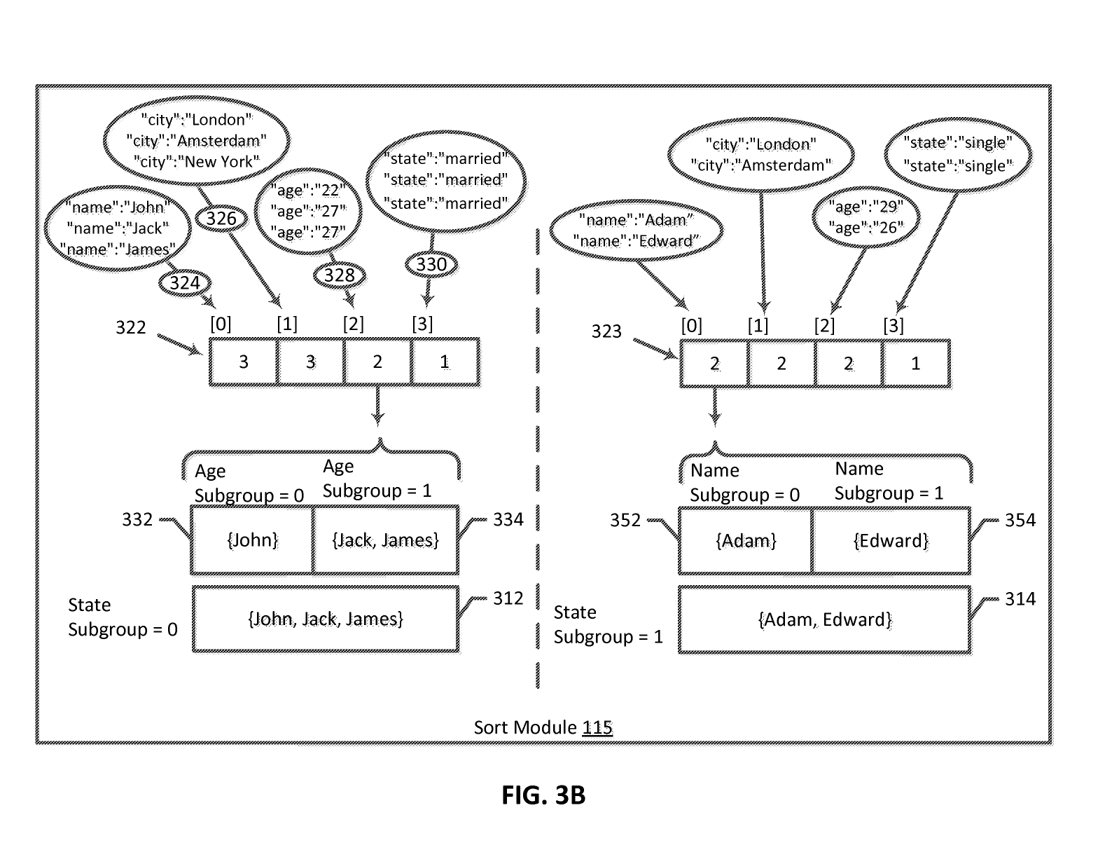

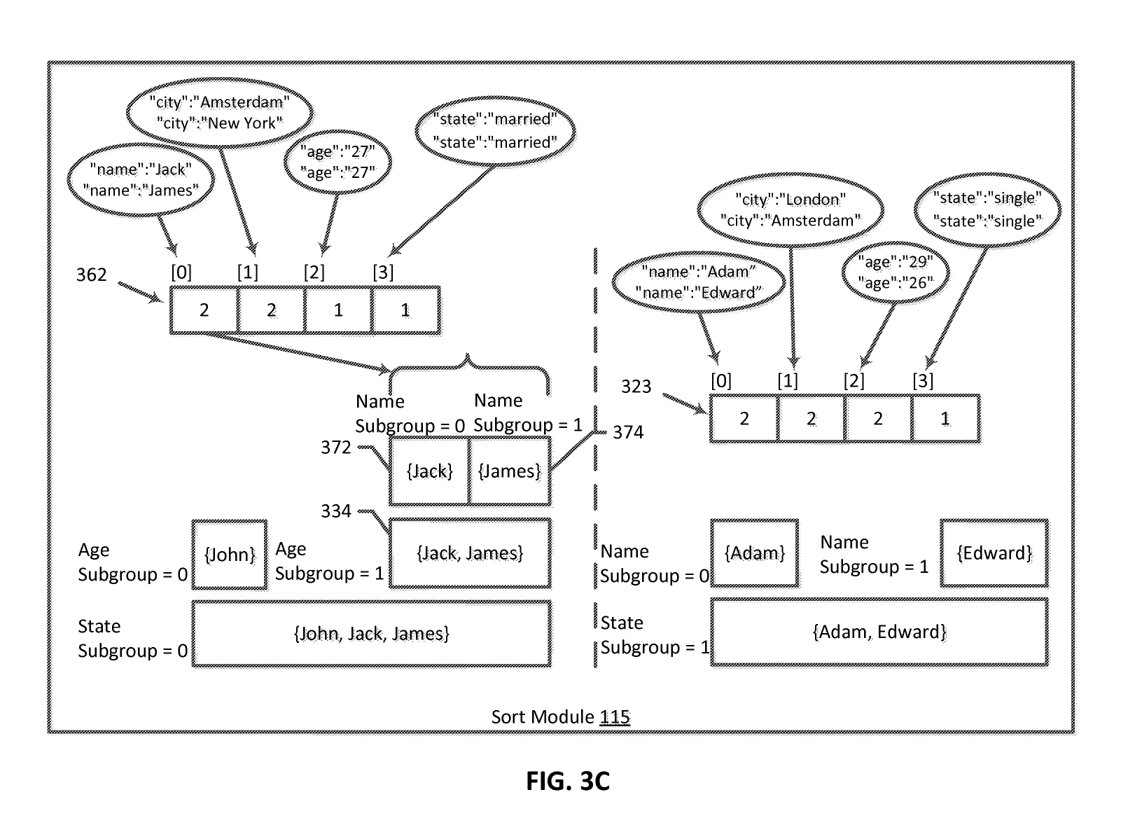

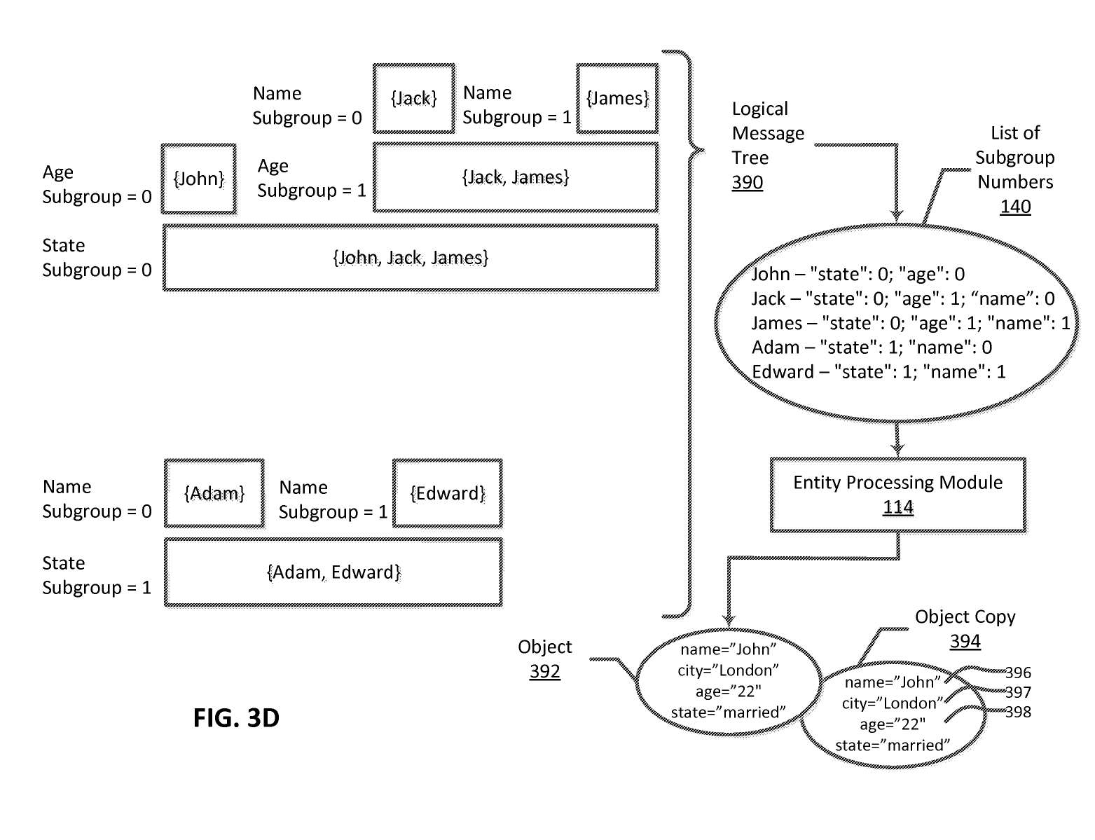

FIGS. 3A-3C are process flow diagrams of server 104 sorting the list of entities and assigning a subgroup number to a plurality of the entity's attribute names by which the divisions are based, according to some embodiments. FIG. 3A illustrates a first level division of unsorted list of entities 132A into a plurality of subgroups based on the attribute name “state,” according to some embodiments. In FIG. 3A, sort module 118 reads unsorted list of entities 132A and parses it. Sort module 118 may load the entities and read all of them row-by-row so that sort module 118 can read particular attribute values and compare them.

Sort module 118 counts the number of tuples each of the entities has. Sort module 118 creates an array 302 having an array length of M, where M is the number of tuples included in an entity in the list. In unsorted list of entities 132A, each of the entities has four tuples. Accordingly, array 302 has a length of four. For each common attribute name in the list of entities, sort module 118 determines a number of different values for the common attribute name and stores the number as an element of array 302. For the attribute name “name,” entity 202 has the value “John,” entity 204 has the value “Jack,” entity 206 has the value “Adam,” entity 208 has the value “James,” and entity 210 has the value “Edward.” For the attribute name “name,” sort module 118 compares each of these values and determines that each of the entities in unsorted list of entities 132A has a different value from each other. At an action 304, sort module 118 determines that the attribute name “name” has five different values (e.g., “John,” “Jack,” “Adam,” “James,” and “Edward”), and assigns “5” to the first element of array 302 at index [0]. The first element of array 302 at index [0] is associated with the attribute name “name” because this element represents the number of different values the entities in unsorted list of entities 132A have for this attribute name.

Sort module 118 may fill in elements of array 302 using the actions described in relation to storing the first element of array 302. For example, for the attribute name “city,” entity 202 has the value “London,” entity 204 has the value “Amsterdam,” entity 206 has the value “London,” entity 208 has the value “New York,” and entity 210 has the value “Amsterdam.” For the attribute name “city,” sort module 118 compares each of these values and determines that entities 202 and 206 have the same value as each other, and entities 204 and 210 have the same value as each other. At an action 306, sort module 118 determines that the attribute name “city” has three different values (e.g., “London,” “Amsterdam,” and “New York”), and assigns “3” to the second element of array 302 at index [1]. The second element of array 302 at index [1] is associated with the attribute name “city” because this element represents the number of different values the entities in unsorted list of entities 132A have for this attribute name.

For the attribute name “age,” entity 202 has the value “22,” entity 204 has the value “27,” entity 206 has the value “29,” entity 208 has the value “27,” and entity 210 has the value “26.” For the attribute name “age,” sort module 118 compares each of these values and determines that entities 204 and 208 have the same value as each other. At an action 308, sort module 118 determines that the attribute name “age” has four different values (e.g., “22,” “27,” “29,” and “26”), and assigns “4” to the third element of array 302 at index [2]. The third element of array 302 at index [2] is associated with the attribute name “age” because this element represents the number of different values the entities in unsorted list of entities 132A have for this attribute name.

For the attribute name “state,” entity 202 has the value “married,” entity 204 has the value “married,” entity 206 has the value “single,” entity 208 has the value “married,” and entity 210 has the value “single.” For the attribute name “state,” sort module 118 compares each of these values and determines that entities 202, 204, and 208 have the same value as each other, and entities 206 and 210 have the same value as each other. At an action 310, sort module 118 determines that the attribute name “state” has two different values (e.g., “married” and “single”), and assigns “2” to the fourth element of array 302 at index [3]. The fourth element of array 302 at index [3] is associated with the attribute name “state” because this element represents the number of different values the entities in unsorted list of entities 132A have for this attribute name.

Sort module 118 compares the four elements in array 302 and identifies the smallest number in array 302. The smaller the number that is associated with an attribute name, the greater the similarity of entities with respect to that particular attribute name. Sort module 118 selects the smallest number and divides unsorted list of entities 132A into a corresponding number of subgroups. In other words, sort module 118 selects the smallest number “S_{number}” in array 302, and divides unsorted list of entities 132A into S_{number} subgroups based on the attribute name associated with the smallest number, where S_{number} is an integer. At each level of division, each entity in a common subgroup has the same value for the attribute name by which the list of entities or subgroups was divided.

In FIG. 2, the smallest number in array 302 is “2,” which is associated with the attribute name “state.” Sort module 118 divides unsorted list of entities 132A into two subgroups, which are a state subgroup 312 and a state subgroup 314, based on the attribute name “state.” State subgroup 312 includes entities 202, 204, and 208, and state subgroup 314 includes entities 206 and 210. The subgroup to which an entity belongs may be represented by the entity's first listed attribute value. Referring to FIG. 2, “name” is the first attribute listed in the “employees” entity type, and the value of the “name” attribute may represent the entities. In this example, state subgroup 312 includes “John,” “Jack,” and “James,” and state subgroup 314 includes “Adam” and “Edward.” This is not intended to be limiting, and an entity may be represented by any of the entity's attribute values.

Sort module 118 assigns a subgroup number to each of the subgroups. For example, at the “state” division, sort module 118 assigns a subgroup number “0” to state subgroup 312 and a state subgroup number “1” to subgroup 314. A subgroup number provides an indication of entities that have the same value for the attribute name by which the division was made. In FIG. 3A the subgroup number ranges from 0 to (S_{number}−1). At each level of division, the entity's attribute name by which the division is made is assigned the entity's subgroup number. For example, at the first level of division, entity 202's, entity 204's, and entity 208's attribute name “state” is assigned the subgroup number “0,” and entity 206's and entity 210's attribute name “state” is assigned the subgroup number “1.” This is not intended to be limiting, and the subgroup number can be any symbol that can be used to group entities together or to differentiate them. In another example, the subgroup number may range from 1 to S_{number}. In another example, the subgroup number may be a letter (e.g., “A” and “B”).

### B. Recursively Divide the Subgroups Based on an Attribute Name

Sort module 118 recursively performs the above actions, and continues to divide the subgroups until each entity in a subgroup has the same attribute name-value pairs. If each entity in a subgroup has the same attribute name-value pairs, that particular subgroup is not divided anymore. If a subgroup includes only a single entity, the entity in the subgroup has a single attribute name-value pair and is not divided anymore. Sort module 118 remembers the attribute name for each division of the entities into further subgroups, and generates a list of subgroup numbers 140 based on the divisions.

Sort module 118 may create and/or set the values of an array for each of the subgroups. FIG. 3B illustrates a second level division of unsorted list of entities 132A into subgroups based on the attribute name “age” for state subgroup 312 and the attribute name “name” for state subgroup 314, according to some embodiments. In FIG. 3B, sort module 118 sets an array 322 for state subgroup 312 and sets an array 323 for state subgroup 314. The array length of each of these arrays is M, where M is the number of tuples included in an entity in the list. Arrays 322 and 324 have a length of four. For each common attribute name in a subgroup, sort module 118 determines a number of different values for the common attribute name.

### 1. Second Level of Division

### A Division Based on State Subgroup “0” and Attribute Name “Age”

In FIG. 3B, in reference to state subgroup 312 and the attribute name “name,” entity 202 has the value “John,” entity 204 has the value “Jack,” and entity 208 has the value “James.” For the attribute name “name,” sort module 118 compares each of these values and determines that each of the entities in state subgroup 312 has a different value from each other. At an action 324, sort module 118 determines that the attribute name “name” has three different values (e.g., “John,” “Jack,” and “James”), and assigns “3” to the first element of array 322 at index [0]. The first element of array 322 at index [0] is associated with the attribute name “name” because this element represents the number of different values the entities in state subgroup 312 have for this attribute name.

Additionally, for the attribute name “city,” entity 202 has the value “London,” entity 204 has the value “Amsterdam,” and entity 208 has the value “New York.” For the attribute name “city,” sort module 118 compares each of these values and determines that each of the entities in state subgroup 312 has a different value from each other. At an action 326, sort module 118 determines that the attribute name “city” has three different values (e.g., “London,” “Amsterdam,” and “New York”), and assigns “3” to the second element of array 322 at index [1]. The second element of array 322 at index [1] is associated with the attribute name “city” because this element represents the number of different values the entities in state subgroup 312 have for this attribute name.

Additionally, for the attribute name “age,” entity 202 has the value “22,” entity 204 has the value “27,” and entity 208 has the value “27.” For the attribute name “age,” sort module 118 compares each of these values and determines that entities 202 and 204 have the same value as each other. At an action 328, sort module 118 determines that the attribute name “age” has two different values (e.g., “22” and “27”), and assigns “2” to the third element of array 322 at index [2]. The third element of array 322 at index [2] is associated with the attribute name “age” because this element represents the number of different values the entities in state subgroup 312 have for this attribute name.

If unsorted list of entities 132A or a subgroup has already been divided based on a particular attribute name, the element of the array corresponding to the subsequent division and associated with that particular attribute name is one. For example, at the first level of division, unsorted list of entities 132A is divided based on the attribute name “state” (see FIG. 3A). Accordingly, each of the entities in the common state subgroup 312 has the same value for the attribute name “state,” and thus matching attribute name-value pairs. In particular, the value of the attribute name “state” for each of entities 202, 204, and 208 in state subgroup “0” is “married.” At an action 330, sort module 118 assigns “1” to the fourth element of array 332 at index [3]. The fourth element of array 332 at index [3] is associated with the attribute name “state” because this element represents the number of different values the entities in state subgroup 312 have for this attribute name.

Sort module 118 compares the elements in array 322 and identifies the smallest number in array 302, excluding any elements by which a division has already been made in relation to the array. For example, sort module 118 may identify each of the elements in array 322 that is not associated with an attribute name by which a division has already been made, and may select the smallest element. The attribute name “state” corresponds to a division that has already been made because unsorted list of entities 132A has already been divided based on this attribute name (see FIG. 3A). Accordingly, sort module 118 compares “3” (first element of array 322 and associated with the attribute name “name”), “3” (second element of array 322 and associated with the attribute name “city”), and “2” (third element of array 322 and associated with the attribute name “age”) to each other. Sort module 118 selects the smallest number of these three numbers, which is “2,” and divides state subgroup 312 into a corresponding number of subgroups. In other words, sort module 118 selects the smallest number “S_{number},” and divides subgroup 312 into S_{number} subgroups.

Sort module 118 divides state subgroup 312 into an age subgroup 332 and an age subgroup 334 based on the attribute name “age,” and assigns a subgroup number to each of these subgroups. For example, at the “age” division, sort module 118 assigns a subgroup number “0” to age subgroup 332 and a subgroup number “1” to age subgroup 334. Age subgroup 332 includes entity 202, and age subgroup 334 includes entities 204 and 208. At each level of division, the entity's attribute name by which the division is made is assigned the entity's subgroup number. For example, at the second level of division, entity 202's attribute name “age” is assigned the subgroup number “0,” and entity 204's and entity 208's attribute name “age” is assigned the subgroup number “1.” Age subgroup 332 includes a single entity 202. Accordingly, sort module 118 stops dividing this subgroup, but continues dividing other subgroups in which entities do not have all matching attribute name-value pairs.

b. Division Based on State Subgroup “1” and Attribute Name “Name”

Sort module 118 may perform actions similar to those described with respect to state subgroup 312 to state subgroup 314, which corresponds to array 323. Sort module 118 assigns “2” to the first element of array 323 at index [0], assigns “2” to the second element of array 323 at index [1], assigns “2” to the third element of array 323 at index [2], and assigns “1” to the fourth element of array 323 at index [3]. Sort module 118 compares “2” (first element of array 323 and associated with the attribute name “name”), “2” (second element of array 323 and associated with the attribute name “city”), and “2” (third element of array 323 and associated with the attribute name “age”) to each other. If the smallest number in the array is the same as the other numbers compared in the array, sort module 118 may select any of the attribute names associated with those numbers to divide the subgroup. In the example illustrated in FIG. 3B, sort module 118 selects the first element in array 323, which is associated with the attribute name “name,” and divides state subgroup 314 based on this attribute name. Alternatively, sort module 118 may have selected the second element and divided state subgroup 314 based on the attribute name “city.” Alternatively, sort module 118 may have selected the third element and divided state subgroup 314 based on the attribute name “age.”

In FIG. 3B, sort module 118 divides state subgroup 314 into a name subgroup 352 and a name subgroup 354 based on the attribute name “name,” and assigns a subgroup number to each of these subgroups. For example, at the “name” division, sort module 118 assigns a subgroup number “0” to name subgroup 352 and a subgroup number “1” to name subgroup 354. Name subgroup 352 includes entity 206, and name subgroup 354 includes entity 210. At each level of division, the entity's attribute name by which the division is made is assigned the entity's subgroup number. For example, at the second level of division, entity 206's attribute name “name” is assigned the subgroup number “0,” and entity 210's attribute name “name” is assigned the subgroup number “1.” Name subgroup 352 includes a single entity 206, and name subgroup 354 includes a single entity 210. Accordingly, sort module 118 stops dividing these two subgroups further because each of name subgroups 352 and 354 includes entities having all of the same attribute name-value pairs.

At this point, each of age subgroup 332, name subgroup 352, and name subgroup 354 includes a single entity. Accordingly, sort module 118 stops dividing age subgroup 332, name subgroup 352, and name subgroup 354. Sort module 118 continues to divide a subgroup until all entities within that subgroup have the same attribute name-value pairs. If all entities within a subgroup have the same attribute name-value pairs, all elements of an array associated with that subgroup are one.

In some embodiments, sort module 118 continues to create and set arrays for subgroups until each element in the array corresponding to the subgroup is “1.” For example, sort module 118 may create an array for name subgroup 352, which includes only entity 206 (Adam). In this example, sort module 118 may assign “1” to the first element in the array because the only value for the attribute name “name” in name subgroup 352 is “Adam,” may assign “1” to the second element in the array because the only value for the attribute name “city” in name subgroup 352 is “London,” may assign “1” to the third element in the array because the only value for the attribute name “age” in name subgroup 352 is “29,” and may assign “1” to the fourth element in the array because the only value for the attribute name “state” in name subgroup 352 is “single.” Accordingly, each of the elements in the array is “1,” and thus sort module 118 may stop dividing this subgroup.

### 2. Third Level of Division Based on State Subgroup “0,” Age Subgroup “1,” and Attribute Name “Name”

The only subgroup left including one or more entities having different attribute name-value pairs is age subgroup 334, which sort module 118 continues to divide into subgroups. FIG. 3C illustrates a third level of division of unsorted list of entities 132A into subgroups based on the attribute name “name,” according to some embodiments. Sort module 118 may perform actions similar to those described with respect to state subgroup 312 to age subgroup 334, which includes entities 204 and 208. Sort module 118 creates and/or sets an array 362 and assigns “2” to the first element of array 362 at index [0], assigns “2” to the second element of array 362 at index [1], assigns “1” to the third element of array 362 at index [2], and assigns “1” to the fourth element of array 362 at index [3].

Sort module 118 compares “2” (first element of array 362 and associated with the attribute name “name”) and “2” (second element of array 362 and associated with the attribute name “city”) to each other to identify the smaller number. Sort module 118 does not include the third or fourth element of array 362 in the comparison because a division has already been made based on their associated attribute names. If all of the compared numbers are the same, sort module 118 may select any of the attribute names corresponding to these compared numbers and divide the subgroup based on the selected attribute name. In the example illustrated in FIG. 3C, sort module 118 selects the first element associated with the attribute name “name,” and divides age subgroup 334 based on this attribute name.

Sort module 118 divides age subgroup 334 into a name subgroup 372 and a name subgroup 374 based on the attribute name “name,” and assigns a subgroup number to each of these subgroups. For example, at the “name” division, sort module 118 assigns a subgroup number “0” to name subgroup 372 and a subgroup number “1” to name subgroup 374. Name subgroup 372 includes entity 204, and name subgroup 374 includes entity 208. At each level of division, the entity's attribute name by which the division is made is assigned the entity's subgroup number. For example, at the third level of division, entity 204's attribute name “name” is assigned the subgroup number “0,” and entity 208's attribute name “name” is assigned the subgroup number “1.” Name subgroup 372 includes a single entity 204, and name subgroup 374 includes a single entity 208. Each entity in name subgroup 372 has the same attribute name-value pairs, and each entity in name subgroup 374 has the same attribute name-value pairs. Accordingly, sort module 118 stops dividing these two subgroups further.

### C. List of Subgroup Numbers

FIG. 3D illustrates a logical message tree of entities 390 created based on the divisions illustrated in FIGS. 3A-3C, according to some embodiments. Parser 120 generates list of subgroup numbers 140 based on the one or more divisions of unsorted list of entities 132A into subgroups and the subgroup numbers assigned to the entity attribute names. Each entity has its position in the tree depending on its assigned subgroup number(s).

As illustrated in list of subgroup numbers 140, John's (entity 202), Jack's (entity 204), and James's (entity 208) attribute name “state” is assigned the subgroup number “0”, and Adam's (entity 206) and Edward's (entity 210) attribute name “state” is assigned the subgroup number “1” (see FIG. 3A). Additionally, John's attribute name “age” is assigned the subgroup number “0”, and Jack's attribute name “age” is assigned the subgroup number “1” (see FIG. 3B), and so on.

If adjacent entities have the same subgroup number assigned to a common attribute name, these entities have matching attribute-name pairs and are thus similar in this regard. If adjacent entities have different subgroup numbers assigned to a common attribute name, these entities may not have matching attribute-name pairs and thus may be dissimilar in this regard. List of subgroup numbers 140 includes the entities in an order based on their similarities. List of subgroup numbers 140 is based on the assigned subgroup numbers. The most similar entities are next to each other in list of subgroup numbers 140 until the first listed attribute name of an entity has a different subgroup number than the previous entity. The order of the entities in list of subgroup numbers 140 is John, Jack, James, Adam, and Edward. Accordingly, John is the most similar to Jack, Jack is the most similar to John and James, and so on, until Adam, who has a different “state” subgroup number than Jack.

Parser 120 sorts the list of entities in unordered list of entities 132A based on the assigned subgroup numbers, and generates logical message tree 390. An order of the entities in logical message tree 390 is based on the assigned subgroup numbers. In some examples, parser 120 sorts, based on list of subgroup numbers 140, unsorted list of entities 132A from the smallest subgroup number to the biggest subgroup number to determine sorted list of entities 132B. For example, parser 120 may sort unsorted list of entities 132A in ascending order based on their assigned subgroup numbers. In some examples, parser 120 sorts, based on list of subgroup numbers 140, unsorted list of entities 132A from the biggest subgroup number to the smallest subgroup number to determine sorted list of entities 132B. For example, parser 120 may sort unsorted list of entities 132A in descending order based on their assigned subgroup numbers.

Parser 120 sorts unordered list of entities 132A based on the order of the entities in logical message tree 390. In other words, parser 120 sorts unsorted list of entities 132A such that the entities are in the same order as they appear in list of subgroup numbers 140. In the example illustrated in FIG. 3D, an order of entities listed in sorted list of entities 132B is entity 202 (John), entity 204 (Jack), entity 208 (Jack), entity 206 (Adam), and entity 210 (Edward).

Serializer 122 serializes sorted list of entities 132B into a data stream, and transmits the entities in the sorted order over a network to client 102. Serializer 122 may send the entities in sorted list of entities 132B one-by-one in the order in which they are listed. For example, serializer 122 first transmits entity 202 (John entity), then entities 204 (Jack entity), 208 (Jack entity), and 206 (Adam entity), and last entity 210 (Edward entity). Server 104 also transmits list of subgroup numbers 140 to client 102.

### IV. Client-Side Instantiation and Copying of Object Instances

In an example, serializer 122 streams the list of entities as textual data to client 102, and client 102 receives the entities in the data-interchange format along with list of subgroup numbers 140, and converts this data into a format that is understandable to RESTful client application 112. Client 102 may receive the entities in sorted list of entities 132B one-by-one based on their sorted order. For example, client 102 may receive entity 202 (John), which is the first entity listed in sorted list of entities 132B, and then entities 204, 208, 206, and lastly entity 210.

In an example, RESTful client application 112 and entity processing module 114 are written in the JAVA® programming language, and client 102 maps each entity in list of entities 132 to a JAVA object. Trademarks are the properties of their respective owners. To instantiate a new instance of a class in the JAVA programming language, client 102 may read the metadata associated with the class, allocate memory for the instance, and then create the instance. Client 102 maps an entity in list of entities 132 to a JAVA object, and sets each of the object's fields based on the corresponding entity's attributes.

Entity processing module 114 creates a new object 392 for the first entity that is received, which is entity 202. Entity processing module 114 creates a new object 392 of type “Employee” based on entity 202 and sets each of the fields in object 392. Object 392 has a set of fields (four fields) corresponding to entity 202's attributes. Object 392 has a field corresponding to each of the entity's attributes. For example, object 392 based on the “employee” entity may be of an “Employee” class type that includes the fields “name,” “city,” “age,” “and “state.” Object 392 is an instance of the “Employee” class. To set each of object 392's fields, client 102 reads the applicable portion of the JSON data specifying the corresponding entity's attributes. For example, client 102 may read each of the values corresponding to these fields from the JSON data and set the values “John,” “London,” “22,” and “married,” respectively, in the object 392's fields. Entity processing module 114 may preserve object 392 so that it can be used later.

Client 102 may then receive entity 204 (Jack), which is the second entity in sorted list of entities 132B. List of subgroup numbers 140 includes a first set of subgroup numbers assigned to one or more attribute names in entity 202, and a second set of subgroup numbers assigned to one or more attribute names in entity 204. Entity processing module 114 compares the first set of subgroup numbers corresponding to the previously received entity (entity 202) to the second set of subgroup numbers corresponding to the current entity (entity 204). Entity processing module 114 may compare the subgroup numbers one-by-one starting with the first attribute name listed in list of subgroup numbers 140 to the last attribute name listed.

Entity processing module 114 may copy object 392 to represent entity 204 if entity 202's first listed subgroup number matches entity 204's first listed subgroup number. In FIG. 3D, John's state subgroup number and Jack's state subgroup number match because they are the same. Accordingly, entity processing module 114 may create an object copy 394 of object 392. In an example, entity processing module 114 copies object 392 by invoking a direct memory copy of the object. In an example, entity processing module 114 may invoke the JAVA clone ( ) method. In this example, to ensure that the “Employee” object 392 is capable of being cloned, the clone ( ) method may be implemented in the “Employee” class. Entity processing module 114 may copy “Employee” object 392 by calling the clone ( ) method, which may make a bitwise copy of the original object and return the reference of the copy. To access object copy 394, client 102 may use the returned reference to manipulate the object.

An advantage of copying objects may provide an improvement of the speed by which entities are converted into objects (e.g., JAVA objects) because it becomes unnecessary for entity processing module 114 to repeatedly create objects and set them. Rather, entity processing module 114 takes an already created object that has been initialized, copies it, and modifies fields in the copy to reflect the proper entity.

Entity processing module 114 goes through the first set of subgroup numbers assigned to one or more attribute names in entity 202, and the second set of subgroup numbers assigned to one or more attribute names in entity 204. In FIG. 3D, entity 202 (John) and entity 204 (Jack) have the same state subgroup number, which means their state values are the same, but different age subgroup numbers, which means their age values are different. If their corresponding subgroup numbers are different, entity processing module 114 does not go on to compare the subsequent (if any) subgroup numbers and stops comparing the subgroup numbers.

Entity processing module 114 copies the object instance based on entity 202 along with its state value, and fills in the remaining fields. Entity processing module 114 may set, based on entity 204's attributes, one or more fields in the copy. Entity processing module 114 sets the appropriate fields in the object copy to reflect the true attribute value(s) as specified in the JSON data. In an example, entity processing module 114 leaves the state field as “married” because entity 202 and entity 204 have the same value for the attribute name “state,” but sets the age field 398, the city field 397, and the name field 396 values in copy 394 to reflect entity 204's age, city, and name values from the JSON data. Object copy 394 represents entity 204, and entity processing module 114 may preserve object copy 394 corresponding to entity 204 so that it can be used later.

By creating an object copy 394 of object 392, which corresponds to entity 202, it may be unnecessary for entity processing module 114 to go through the arduous and time consuming process of creating a new object and reading each of entity 204's attributes to create an object that represents entity 204. Rather, entity processing module 114 may create a direct memory copy of the already created and initialized object 392, leave those fields in object copy 394 that match object 392's corresponding fields, and modify those fields in object copy 394 that do not match object 392's corresponding fields. Accordingly, one or more of the object copy 394's fields will already be set and it may be unnecessary for client 102 to read each and every one of the entity 204's attributes from the JSON data and set each and every field in the object. Rather, entity processing module 113 may modify one or more of the object copy 394's fields to reflect the proper entity. In this way, client 102 receives sorted list of entities 132B and is able to create fewer objects than the number of entities in the list.

Client 102 may receive entity 208 (James), which is the third entity in sorted list of entities 132B, and performs actions similar to those described in relation to receiving entity 204. Entity processing module 114 may create a copy of the object that represents Jack, keep the state and age fields unchanged, and modify the name and city fields in the object copy to represent entity 208.

Client 102 may then receive entity 206 (Adam), which is the fourth entity in sorted list of entities 132B, and compares the subgroup numbers of previously received entity 208 (James) and current entity 206 (Adam). Entity 208 (James) and entity 206 (Adam) have different state subgroup numbers assigned to the attribute name “state,” which means their state values are different. Entity processing module 114 stops comparing the subgroup numbers and creates a new object of type “Employee” based on entity 206 and sets each of the fields in the new object by reading the JSON data specifying entity 206's attributes. The object has four fields with values corresponding to entity 206. Entity processing module 114 may preserve the new object instance so that it can be used later.

Client 102 may then receive entity 210 (Edward), which is the fifth entity in sorted list of entities 132B. List of subgroup numbers 140 includes a third set of subgroup numbers assigned to one or more attribute names in entity 206, and a fourth set of subgroup numbers assigned to one or more attribute names in entity 210. Entity processing module 114 compares the third set of subgroup numbers corresponding to the previously received entity (entity 206) to the fourth set of subgroup numbers corresponding to the current entity (entity 210). Entity processing module 114 may compare the subgroup numbers one-by-one starting with the first attribute name listed in list of subgroup numbers 140 to the last attribute name listed. Entity 206 (Adam) and entity 210 (Edward) have the same state subgroup number, which means their state values are the same, but different name subgroup numbers, which means their name values are different.

Entity processing module 114 copies the object based on entity 206 along with its state value, and fills in the remaining values. Entity processing module 114 sets the age, city, and name values in the copy to reflect entity 210's age, city, and name values from the JSON data. Accordingly, rather than create five new objects to instantiate the five entities listed, entity processing module 114 creates only two new objects and creates copies to represent the others. The present disclosure leverages the similarities between entities to reduce the number of objects that are created and set.

As discussed above and further emphasized here, FIGS. 1, 2, and 3A-3D are merely examples, which should not unduly limit the scope of the claims. For example, it should be understood that one or more modules or components in FIG. 1 (e.g., RESTful web service 116, sort module 118, parser 120, or serializer 122) may be combined with another module or component. Additionally, entity processing module 114 may be incorporated into RESTful client application 112. It should also be understood that one or more modules or components in FIG. 1 may be separated into more than one module or component.

Further, in the above description, although sort module 118 creates an array of length M corresponding to list of entities 132 or the subgroup, where M is the number of tuples included in an entity in the list, this is not intended to be limiting. In other examples, sort module 118 creates an array of length Q, where Q is the number of attribute names by which a division has not yet been made in relation to the list of entities 132 or subgroups. For example, in reference to FIG. 3B after list of entities 132 has been divided based on the attribute name “state,” sort module 118 may create an array of length three because there are only three other attribute names by which a division has not yet been made (e.g., name, city, and age). Sort module 118 may then compare the elements in this array to select the smallest number in the array and stop recursively dividing an array if each element in the array is one.

### V. Example Methods

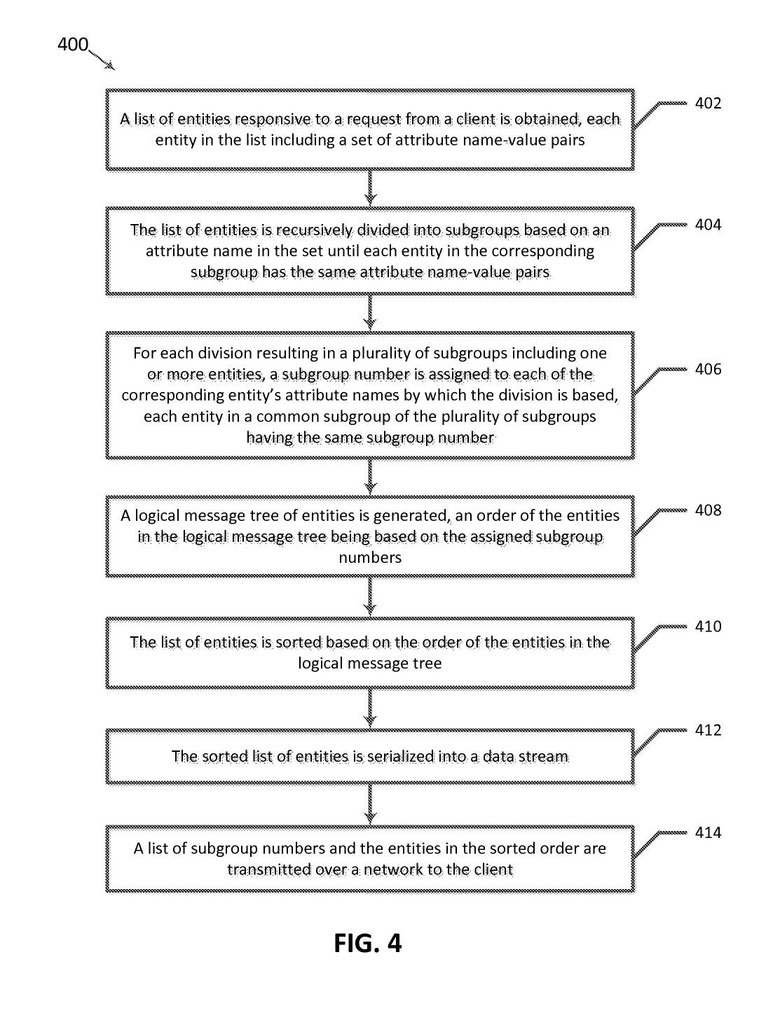

FIG. 4 is a flowchart illustrating a method 400 of providing a list of entities, according to some embodiments. Method 400 is not meant to be limiting and may be used in other applications.

In FIG. 4, method 400 includes blocks 402-414. In a block 402, a list of entities responsive to a request from a client is obtained, each entity in the list including a set of attribute name-value pairs. In an example, server 104 obtains list of entities 132 responsive to request 124 from client 102, each entity in the list including a set of attribute name-value pairs. In a block 404, the list of entities is recursively divided into subgroups based on an attribute name in the set until each entity in the corresponding subgroup has the same attribute name-value pairs. In an example, sort module 118 divides list of entities 132 into state subgroups 312 and 314 based on the attribute name “state” in the set until each entity in the corresponding subgroup has the same attribute name-value pairs.

In a block 406, for each division resulting in a plurality of subgroups including one or more entities, a subgroup number is assigned to each of the corresponding entity's attribute names by which the division is based, each entity in a common subgroup of the plurality of subgroups having the same subgroup number. In an example, for each division resulting in a plurality of subgroups including one or more entities, sort module 118 assigns a subgroup number to each of the corresponding entity's attribute names by which the division is based, each entity in a common subgroup of the plurality of subgroups having the same subgroup number.

In a block 408, a logical message tree of entities is generated, an order of the entities in the logical message tree being based on the assigned subgroup numbers. In an example, parser 120 generates logical message tree of entities 390, an order of the entities in logical message tree 390 being based on the assigned subgroup numbers. In a block 410, the list of entities is sorted based on the order of the entities in the logical message tree. In an example, parser 120 sorts the list of entities based on the order of the entities in logical message tree 390 to obtain sorted list of entities 132B.

In a block 412, the sorted list of entities is serialized into a data stream. In an example, serializer 122 serializes sorted list of entities 132B into a data stream. In a block 414, a list of subgroup numbers and the entities in the sorted order are transmitted over a network to the client. In an example, server 104 transmits list of subgroup numbers 140 and sorted list of entities 132B over a network to client 102.

In some embodiments, one or more actions illustrated in blocks 402-414 may be performed for any number of requests received by the server. It is also understood that additional processes may be performed before, during, or after steps 402-414 discussed above. It is also understood that one or more of the steps of method 400 described herein may be omitted, combined, or performed in a different sequence as desired.

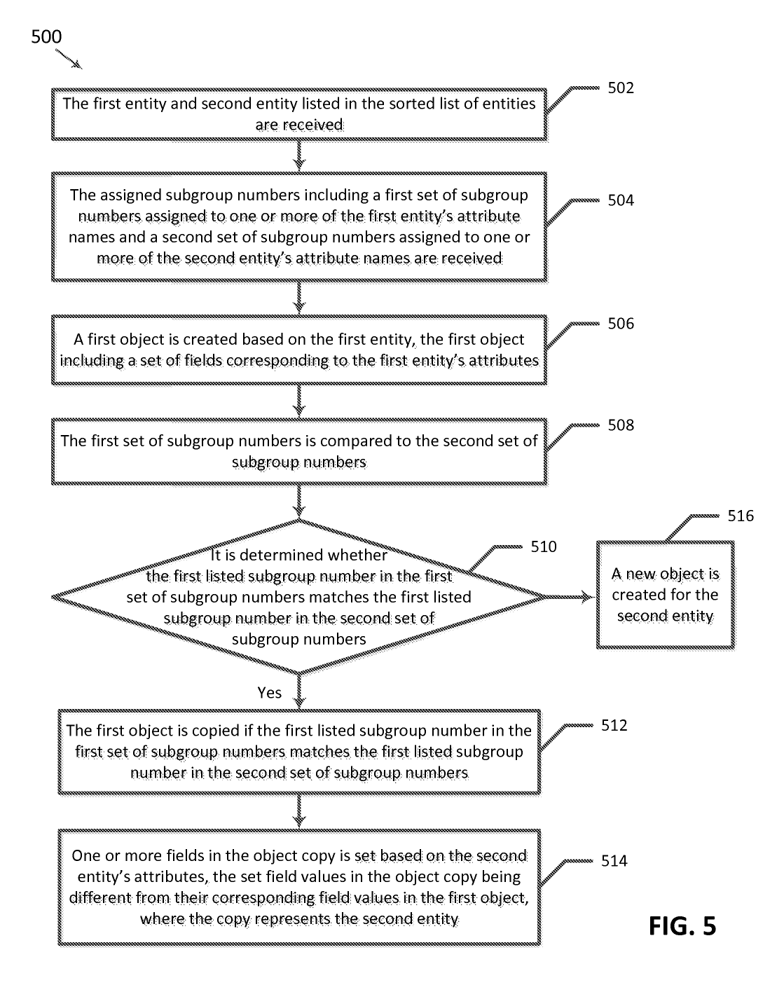

FIG. 5 is a flowchart illustrating a method 500 of converting entities into objects, according to some embodiments. Method 500 is not meant to be limiting and may be used in other applications.

In FIG. 5, method 500 includes blocks 502-516. In a block 502, the first entity and second entity listed in the sorted list of entities are received. In an example, client 102 receives entity 202, which is the first listed entity, and entity 204, which is the second listed entity, in sorted list of entities 132B. In a block 504, the assigned subgroup numbers including a first set of subgroup numbers assigned to one or more of the first entity's attribute names and a second set of subgroup numbers assigned to one or more of the second entity's attribute names are received. In an example, client 102 receives list of subgroup numbers 140, which includes the assigned subgroup numbers including a first set of subgroup numbers assigned to one or more of entity 202's attribute names and a second set of subgroup numbers assigned to one or more of entity 204's attribute names.

In a block 506, a first object is created based on the first entity, the first object including a set of fields corresponding to the first entity's attributes. In an example, entity processing module 114 creates object 392 based on entity 202, object 392 including a set of fields “name,” “city,” “age,” and “state” corresponding to entity 202's attributes. In a block 508, the first set of subgroup numbers is compared to the second set of subgroup numbers. In an example, entity processing module 114 compares the first set of subgroup numbers to the second set of subgroup numbers. In a block 510, it is determined whether the first listed subgroup number in the first set of subgroup numbers matches the first listed subgroup number in the second set of subgroup numbers. In an example, sort module 115 determines whether state subgroup number “0” corresponding to entity 202 matches state subgroup number “0” corresponding to entity 204.

If the first listed subgroup number in the first set of subgroup numbers matches the first listed subgroup number in the second set of subgroup numbers, process flow proceeds from block 510 to a block 512, in which the first object is copied. In an example, entity processing module 114 copies object 392 if state subgroup number “0” corresponding to entity 202 matches state subgroup number “0” corresponding to entity 204. Process flow proceeds from block 512 to a block 514, in which one or more fields in the object copy is set based on the second entity's attributes, the set field values in the object copy being different from their corresponding field values in the first object, where the copy represents the second entity. In an example, entity processing module 114 sets, based on entity 204's attributes, one or more fields in object copy 394, the set field values in object copy 394 being different from their corresponding field values in object 392, where object copy 394 represents entity 204.

If the first listed subgroup number in the first set of subgroup numbers does not match the first listed subgroup number in the second set of subgroup numbers, process flow proceeds from block 510 to a block 516, in which a new object is created for the second entity. In an example, entity processing module 114 creates a new object for entity 204 if the first listed subgroup number in the first set of subgroup numbers does not match the first listed subgroup number in the second set of subgroup numbers.

In some embodiments, one or more actions illustrated in blocks 502-516 may be performed for any number of sorted lists of entities received by the client. It is also understood that additional processes may be performed before, during, or after steps 502-516 discussed above. It is also understood that one or more of the steps of method 500 described herein may be omitted, combined, or performed in a different sequence as desired.

### VI. Example Computing System

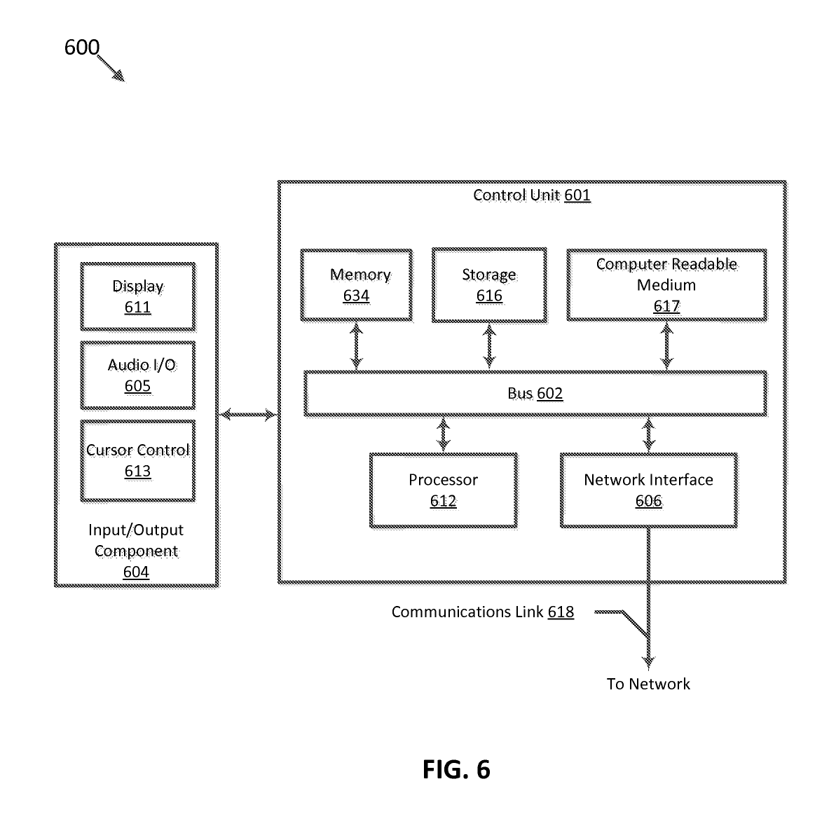

FIG. 6 is a block diagram of an example computer system 600 suitable for implementing any of the embodiments disclosed herein. In various implementations, each of RESTful web service 116, sort module 118, parser 120, serializer 122, RESTful client application 112, and entity processing module 114 may be implemented on computer system 600. The computer system 600 may include one or more processors 612. The computer system 600 may additionally include one or more storage devices each selected from a group including floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to a client or server using a computer network (not shown). The computer network may be any type of network including a LAN, a WAN, an intranet, the Internet, a cloud, and/or any combination of networks thereof that is capable of interconnecting computing devices and/or computer programs in the system.

Computer system 600 includes a bus 602 or other communication mechanism for communicating information data, signals, and information between various components of computer system 600. Components include an input/output (I/O) component 604 for processing user actions, such as selecting keys from a keypad/keyboard or selecting one or more buttons or links, etc., and sending a corresponding signal to bus 602. I/O component 604 may also include an output component such as a display 611, and an input control such as a cursor control 613 (such as a keyboard, keypad, mouse, etc.).

An audio I/O component 605 may also be included to allow a user to use voice for inputting information by converting audio signals into information signals. Audio I/O component 605 may allow the user to hear audio. A transceiver or network interface 606 transmits and receives signals between computer system 600 and other devices via a communications link 618 to a network. In an embodiment, the transmission is wireless, although other transmission mediums and methods may also be suitable.

A processor 612, which may be a micro-controller, digital signal processor (DSP), or other processing component, processes these various signals, such as for display on display 611 of computer system 600 or transmission to other devices via communication link 618. A processor may also control transmission of information, such as cookies or IP addresses, to other devices.

Components of computer system 600 also include a system memory component 634 (e.g., RAM), a static storage component 616 (e.g., ROM), and/or a computer readable medium 617. Computer system 600 performs specific operations by one or more processors 612 and other components by executing one or more sequences of instructions contained in system memory component 634. Logic may be encoded in computer readable medium 617, which may refer to any medium that participates in providing instructions to one or more processors 612 for execution. Such a medium may take many forms, including but not limited to, non-volatile media, volatile media, and transmission media. In various implementations, non-volatile media include optical, or magnetic disks, or solid-state drives, volatile media include dynamic memory, such as system memory component 634, and transmission media include coaxial cables, copper wire, and fiber optics, including wires that include bus 602. In an embodiment, the logic is encoded in non-transitory computer readable medium. Computer readable medium 617 may be any apparatus that can contain, store, communicate, propagate, or transport instructions that are used by or in connection with processor 612. Computer readable medium 617 may be an electronic, magnetic, optical, electromagnetic, infrared, or semiconductor device or a propagation medium, or any other memory chip or cartridge, or any other medium from which a computer is adapted to read. In an example, transmission media may take the form of acoustic or light waves, such as those generated during radio wave, optical, and infrared data communications.

In various embodiments of the present disclosure, execution of instruction sequences (e.g., method 400 or method 500) to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various actions described herein may be changed, combined into composite actions, and/or separated into sub-actions to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A method of providing a list of entities, comprising:
obtaining, at a server, a list of entities responsive to a request from a client, each entity in the list including a set of attribute name-value pairs;
recursively dividing the list of entities into subgroups based on an attribute name in the set until each entity in the corresponding subgroup has the same attribute name-value pairs;
for each division resulting in a plurality of subgroups including one or more entities, assigning a subgroup number to each of the corresponding entity's attribute names by which the division is based, each entity in a common subgroup of the plurality of subgroups having the same subgroup number;
generating, at a parser, a logical message tree of entities, an order of the entities in the logical message tree being based on the assigned subgroup numbers;
sorting the list of entities based on the order of the entities in the logical message tree;
serializing the sorted list of entities into a data stream;
transmitting the entities in the sorted order over a network to the client; and
transmitting a list of subgroup numbers to the client, the list of subgroup numbers being based on the assigning.

2. The method of claim 1, wherein the list of entities is in a data-interchange format.

3. The method of claim 1, wherein the data-interchange format is JavaScript Object Notation (JSON).

4. The method of claim 1, wherein the recursively dividing includes dividing the list of entities based on a similarity of attribute name-value pairs among the entities in the list.

5. The method of claim 1, further including:
creating an array having an array length of M, M being the number of attribute name-value pairs included in an entity in the list;
for each common attribute name among the entities in the list, determining a number of different values for the common attribute name; and
assigning each of the determined number of different values to an element of the array, each element of the array representing a number of different values for an attribute name.

6. The method of claim 5, further including:
selecting a smallest number in the array, wherein the recursively dividing includes dividing the list of entities into a corresponding number of subgroups based on the attribute name associated with the smallest number.

7. The method of claim 1, wherein each entity in the list is of a common type having a common set of attribute names.

8. The method of claim 1, further including:
receiving, at a client, the first entity and second entity listed in the sorted list of entities;
receiving, at the client, the assigned subgroup numbers including a first set of subgroup numbers assigned to one or more of the first entity's attribute names and a second set of subgroup numbers assigned to one or more of the second entity's attribute names;
creating a first object based on the first entity, the first object including a set of fields corresponding to the first entity's attributes;
comparing the first set of subgroup numbers to the second set of subgroup numbers; and
copying the first object if the first listed subgroup number in the first set of subgroup numbers matches the first listed subgroup number in the second set of subgroup numbers.

9. The method of claim 8, further including:
setting, based on the second entity's attributes, one or more fields in the object copy, the set field values in the object copy being different from their corresponding field values in the first object, wherein the object copy represents the second entity.

10. The method of claim 8, further including:
creating a second object representative of the second entity if the first listed subgroup number in the first set of subgroup numbers does not match the first listed subgroup number in the second set of subgroup numbers; and
setting each field in the second object based on the second entity's attributes.

11. A system for providing a list of entities, comprising:
a server that obtains a list of entities responsive to a request from a client, wherein each entity in the list includes a set of attribute name-value pairs;
a sort module that recursively divides the list of entities into subgroups based on an attribute name in the set until each entity in the corresponding subgroup has the same attribute name-value pairs, wherein for each division resulting in a plurality of subgroups including one or more entities, the sort module assigns a subgroup number to each of the corresponding entity's attribute names by which the division is based, and wherein each entity in a common subgroup of the plurality of subgroups has the same subgroup number;
a parser that generates a logical message tree of entities, wherein an order of the entities in the logical message tree is based on the assigned subgroup numbers, wherein the parser sorts the list of entities based on the order of the entities in the logical message tree; and
a serializer that serializes the sorted list of entities into a data stream, and transmits a list of subgroup numbers and the entities in the sorted order over a network to the client, wherein the list of subgroup numbers is based on the subgroup number assignments.

12. The system of claim 11, wherein the list of entities is in a data-interchange format.

13. The system of claim 12, wherein the data-interchange format is JavaScript Object Notation (JSON).

14. The method of claim 12, wherein the data-interchange format is Extensible Markup Language (XML).

15. The system of claim 11, wherein the sort module creates an array having an array length of M, wherein for each common attribute name among the entities in the list, the sort module determines a number of different values for the common attribute name, and wherein the sort module assigns each of the determined number of different values to an element of the array, wherein M is the number of attribute name-value pairs included in an entity in the list and each element of the array represents a number of different values for an attribute name.

16. The system of claim 15, wherein the sort module selects a smallest number in the array, and divides the list of entities into a corresponding number of subgroups based on the attribute name associated with the smallest number.

17. The system of claim 11, wherein the sort module creates the list of subgroup numbers based on the subgroup number assignments and the one or more divisions, and wherein the list of subgroup numbers includes the assigned subgroup numbers.

18. The system of claim 11, further including:
a client that receives the first entity and second entity listed in the sorted list of entities, and receives the assigned subgroup numbers including a first set of subgroup numbers assigned to one or more of the first entity's attribute names and a second set of subgroup numbers assigned to one or more of the second entity's attribute names; and
an entity processing module that creates a first object based on the first entity, compares the first set of subgroup numbers to the second set of subgroup numbers, and copies the first object if the first listed subgroup number in the first set of subgroup numbers matches the first listed subgroup number in the second set of subgroup numbers, wherein the first object includes a set of fields corresponding to the first entity's attributes.

19. The system of claim 18, wherein the entity processing module sets, based on the second entity's attributes, one or more fields in the object copy, wherein the set field values in the object copy are different from their corresponding field values in the first object, and wherein the copy represents the second entity.

20. A machine-readable medium comprising a plurality of machine-readable instructions that when executed by one or more processors is adapted to cause the one or more processors to perform a method comprising:
obtaining, at a server, a list of entities responsive to a request from a client, each entity in the list including a set of attribute name-value pairs;
recursively dividing the list of entities into subgroups based on an attribute name in the set until each entity in the corresponding subgroup has the same attribute name-value pairs;
for each division resulting in a plurality of subgroups including one or more entities, assigning a subgroup number to each of the corresponding entity's attribute names by which the division is based, each entity in a common subgroup of the plurality of subgroups having the same subgroup number;
generating, at a parser, a logical message tree of entities, an order of the entities in the logical message tree being based on the assigned subgroup numbers;
sorting the list of entities based on the order of the entities in the logical message tree;
serializing the sorted list of entities into a data stream;
transmitting the entities in the sorted order over a network to the client; and
transmitting a list of subgroup numbers to the client, the list of subgroup numbers being based on the assigning.
